(19) United States
(12) Patent Application Publication
(10) Pub. No.: US 2005/0057089 A1
(43) Pub. Date: Mar. 17, 2005

(54) Brake units

(76) Inventor: Masuhiro Kondo, Obu-shi (JP)

Correspondence Address: BURNS DOANE SWECKER & MATHIS L L P, POST OFFICE BOX 1404, ALEXANDRIA, VA, 22313-1404, US

(21) Appl. No.: 10/928,144

(22) Filed: Aug. 30, 2004

(30) Foreign Application Priority Data
Sep. 16, 2003 (JP) 2003-323181

(51) Int. Cl. B60T 17/04

(52) U.S. Cl. 303/87

(57) ABSTRACT

A brake unit has an actuator for an anti-locking brake function, a piping block, buffer pipes made of an elastic material, and metallic pipes that are attached to the piping block. The piping block is coupled to the actuator via the buffer pipes. The piping block may be attached to the actuator via elastic members. The buffer pipes and elastic members help to isolate and prevent the transmission of the oscillations of the actuator. As a result, the buffer pipes and elastic members inhibit the generation of oscillation-induced unpleasant noise felt by the passengers of the vehicle.

This application claims priority to Japanese patent application serial number 2003-323181, the contents of which are incorporated herein by reference.

### BACKGROUND OF THE INVENTION

1. Field of the Invention

The present invention relates to brake units having an actuator for performing an anti-lock brake function, a piping block, and at least one metal pipe attached to the piping block where the piping block is adapted to be coupled to the actuator.

2. Description of the Related Art

Conventionally, a brake unit described in Japanese Laid-Open Patent Publication No. 10-250549 has been known. This brake unit has an actuator to be coupled between a master cylinder and a wheel cylinder. The actuator has a reservoir to hold operating fluid discharged from the wheel cylinder, a pump for pumping the operating fluid out of the reservoir, and a motor for operating the pump. The actuator is attached to a vehicle body via an elastic member.

Accordingly, the elastic member buffers the oscillation caused by operating the actuator so as to prevent the oscillation from being transmitted to the vehicle body.

However, a plurality of pipes are attached to the actuator. For example, a pipe to couple the actuator to the master cylinder and a pipe to couple the actuator to the wheel cylinder are all attached to the actuator. These pipes are typically metallic pipes. Therefore, when the actuator oscillates, the oscillation is transmitted to the metallic pipes and this leads to the oscillation of the metallic piping. In order to prevent this oscillation from being transmitted to the body of the vehicle, the metallic pipes are attached to the vehicle body via a resin clip so as to absorb the oscillation of the metallic pipes. However, it may be difficult to sufficiently buffer or isolate the oscillation of the metallic pipes solely by the use of the clip. When the oscillation is not sufficiently buffered, part of the oscillation may be transmitted to the vehicle body. The part of the oscillation transmitted to the vehicle body may cause a vibratory or oscillatory noise, resulting in an unpleasant sensation for passengers.

### SUMMARY OF THE INVENTION

It is accordingly an object of the present invention to teach brake units which do not result in an unpleasant sensation felt by passengers by inhibiting the oscillations (vibrations) of an actuator from being transmitted to the metallic pipes.

According to one aspect of the present teachings, brake units are taught that has an actuator for an anti-lock brake function; a piping block; one or more buffer pipes made of an elastic material; and one or more metallic pipes that are attached to the piping block; wherein the piping block is coupled to the actuator via the buffer pipes.

In other words, the actuator is connected to the metallic pipes via the buffer pipe(s) and the piping block. Accordingly, the oscillation of the actuator is buffered by the buffer pipe(s) and therefore the oscillations are prevented from being directly transmitted to the metallic pipe(s). Since the oscillation of the actuator is inhibited from being directly transmitted to the metallic pipe(s), the occurrence of the oscillation noise causing an unpleasant sensation for the passengers is also inhibited.

According to another aspect of the present invention, the piping block is attached to the actuator via a first elastic member.

In more detail, the actuator and the metallic pipe(s) are attached to each other via the first elastic member and attachment means. Accordingly, the first elastic member buffers and isolates the oscillation of the actuator so as to inhibit the oscillations from being easily transmitted to the metallic pipe(s). Consequently, the first elastic member ultimately inhibits the occurrence of the oscillation noise that may have potentially caused an unpleasant sensation for the passengers.

According to yet another aspect of the present invention, the piping block is configured so as to be attached to the body of a vehicle. When the piping block is attached to the body of a vehicle, the actuator is also attached to the vehicle body via the first elastic member and the piping block.

As a result, the oscillations of the actuator are buffered by the first elastic member (located between the actuator and the piping block) and therefore inhibited from being directly transmitted to the vehicle body.

In addition, the first elastic member also inhibits the transmission of the oscillation of the actuator to the metallic pipe(s). As a result, the first elastic member simultaneously plays a roll in inhibiting the oscillation of the actuator from being transmitted to the vehicle body and in inhibiting the oscillation of the actuator from being transmitted to the metallic pipe(s). Therefore, it is possible to effectively inhibit or isolate the oscillation of the actuator.

According to yet another aspect of the present invention, the actuator and the piping block are configured so as to be separately or individually attached to the body of the vehicle. The actuator is attached to the body of the vehicle via a second elastic member.

Since the actuator is attached to the body of the vehicle via the second elastic member, the second elastic member buffers the oscillation of the actuator. Consequently, the second elastic member inhibits the transmission of the oscillation of the actuator to the vehicle body.

On the other hand, the piping block is coupled to the actuator via the buffer pipe(s). Therefore, the piping block does not experience the direct transmission of the oscillations of the actuator. The lack of transmission of oscillations to the piping block allows the separately attached piping block to be directly attached to the vehicle body (i.e., not via an elastic member, buffer, or the like).

According to still another aspect of the present invention, the brake units include at least one of a first retaining structure for attaching the buffer pipe(s) to the actuator and a second retaining structure for attaching the buffer pipe(s) to the piping block. The retaining structure prevents the buffer pipe(s) from being inadvertently removed or separated from the actuator or the piping block in the situations before, during, and after the fluid pressure within the buffer pipe(s) exert an internal force upon the buffer pipe(s) (potentially resulting in a physical expansion of the buffer pipe(s)). Further, when a high fluid pressure physically expands the buffer pipe(s), the retaining structure more securely prevents the buffer pipe(s) from inadvertent removal or separation as compared to the conditions prior to the point when the fluid pressure expands the buffer pipe(s) (i.e., when a lower fluid pressure exists within the buffer pipe(s)).

Accordingly, the buffer pipe(s) can be stably attached to the actuator and/or the piping block by the retaining structures. Particularly, since the buffer pipe(s) is made of an elastic material, fluid pressure within the buffer pipe(s) may expand the buffer pipe(s). However, the retaining structure stably engages the buffer pipe(s).

According to a further aspect of the present invention, the retaining structure has an attaching part that is disposed at a first end portion and/or a second end portion of a buffer pipe(s) and a support part that is disposed at the actuator and/or the piping block. The attaching part has a tapered portion including a tapered surface broadening in circumference towards an end portion of the buffer pipe. The support part is configured so that the attaching part is inserted therein. The support part is also provided with a corresponding tapered portion including a tapered surface so as to securely engage the attaching part. The tapered portions prevent the attaching part from inadvertent removal or separation from the support part due at least in part to the contact between the corresponding tapered portions along the tapered surfaces.

In other words, the retaining structures include the attaching parts of the buffer pipe(s) and the support parts of the actuator and/or the piping block, and both parts have tapered portions. Accordingly, the attaching part and the support part may restrict the movement of the buffer pipe in a removal or separation direction by using the cone angles of the taper portions.

Since the attaching part is inserted into the support part, the attaching part is expanded towards the encircling support part when the fluid pressure (hydraulic pressure) within the buffer pipe exerts an outward force on the buffer pipe. The fluid pressure results in the tapered portion of an attaching part and the tapered portion of a support part closely contacting with one another so as to more strongly and more securely restrict the movement of the buffer pipe in the direction of removal.

Thus, when the fluid pressure expands the buffer pipe(s), the retaining structure may more strongly prevent the removal of the buffer pipe(s) than before the expansion of the buffer pipe(s) (i.e. at a lower fluid pressure).

According to a still further aspect of the present invention, the brake units have a plurality of metallic pipes. Each metallic pipe is coupled to the actuator (through the piping block) via a corresponding buffer pipe.

The piping block may be formed as a single member connected to a plurality of metallic pipes. The piping block may also be configured as having a corresponding plurality of block members that are respectively connected to a plurality of metallic pipes, and a plate part to connect the plurality of block members to each other.

### BRIEF DESCRIPTION OF THE DRAWINGS

FIG. 1 is a perspective view of a first embodiment of a brake unit;

FIG. 2 is an enlarged cross-sectional view of the brake unit of FIG. 1 taken from line II-II;

FIG. 3 is a cross-sectional view of an attaching structure of FIG. 1 taken from line III-III;

FIG. 4 is a perspective view of a second embodiment of a brake unit; and

FIG. 5 is an enlarged cross-sectional view of the brake unit of FIG. 4 taken from line V-V.

### DETAILED DESCRIPTION OF THE INVENTION

Each of the additional features and teachings disclosed above and below may be utilized separately or in conjunction with other features and teachings to provide improved brake unit and methods of using such improved brake units. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

### A FIRST EMBODIMENT

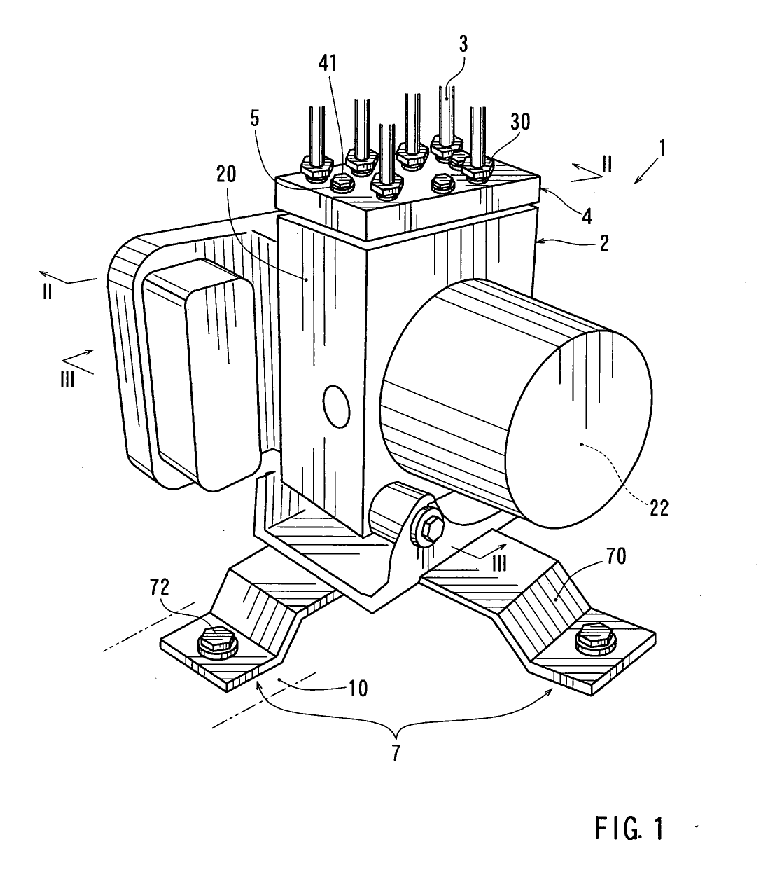

With reference to FIGS. 1 to 3, a first embodiment of the present invention will be described below.

A brake unit 1 according to the first embodiment is a unit for an anti-lock brake system and it serves to prevent a wheel(s) from locking up (i.e., stop rotating while the vehicle is still moving) upon braking.

As shown in FIG. 1, the brake unit 1 has an actuator 2, a piping block 4 attached to the actuator 2, and a plurality of metallic pipes 3 (for example, six as shown in FIG. 1) attached to the piping block 4. Some of the plurality of metallic pipes 3 (four for example in this embodiment) are adapted to connect the actuator 2 to wheel cylinders (not illustrated) and other metallic pipes 3 are adapted to connect the actuator 2 to a master cylinder.

As shown in FIG. 1, the actuator 2 has a housing 20 and a plurality of electromagnetic valves (not illustrated) attached to the housing 20. In the housing 20 a reservoir and a pump (not illustrated) are provided. A motor 22 for operating the pump is attached to the housing 20.

A controller sending a signal based upon the revolving speed of a wheel(s) controls the electromagnetic valves or the like to open and close a fluid path disposed within the actuator 2. For example, electromagnetic valves are provided between the wheel cylinders and the reservoir within housing 20, and when the electromagnetic valves are opened, the operating fluid in the brake circuit corresponding to the wheel cylinder is discharged to the reservoir in order to reduce the hydraulic pressure upon the wheel cylinder.

The operating fluid discharged from the wheel cylinders is held in the reservoir within the housing 20. After discharge into the reservoir, the pump may transfer the operating fluid from the reservoir to the side of the master cylinder via the plurality of metallic pipes 3.

As shown in FIG. 1, the piping block 4 is configured in the form of a thick plate near the upper surface of the housing 20. The metallic pipes 3 are attached to the upper surface side of the piping block 4.

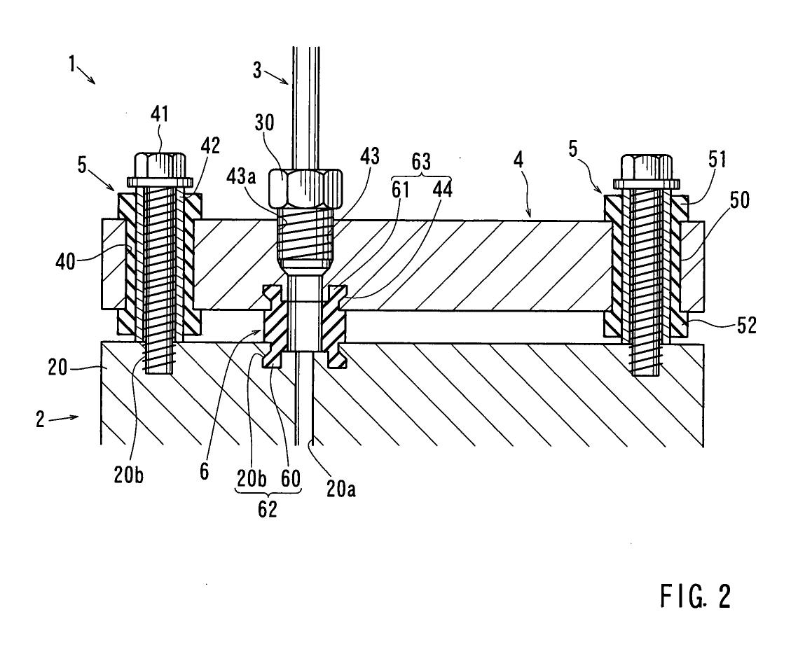

As shown in FIG. 2, the piping block 4 has a plurality of attachment through holes 40 in which attaching members 41 are inserted and a separate plurality of piping through holes 43 to which a corresponding plurality of metallic pipes 3 are attached.

A first elastic member 5 in the form of a tube is inserted into each of the attachment through holes 40. A tubular collar 42 is inserted into the first elastic member 5 and then an attaching member 41 (a bolt in the illustrated example) is inserted into the collar 42.

An elastic material may be molded into the form of first elastic member 5 (for example, materials such as a rubber material and an elastically deformable resin material). As shown in FIG. 2, the first elastic member 5 has a concave portion 50 located around the middle of the circumferential external surface. In addition, the first elastic member 5 has a locking part 51 located at one axial end above (as seen in FIG. 2) the concave portion 50 of the substantially tube shaped member, and a locking part 52 located at the other axial end, below the concave portion 50. The diameters of locking parts 51 and 52 are larger than the diameter of the attachment through hole 40. Accordingly, the first elastic member 5 is inserted into the attachment through hole 40 in such a way so as to respectively lock the upper end surface and the lower end surface of the piping block 4 with locking part 51 and locking part 52. In this way, the first elastic member 5 is attached to the piping block 4.

The collar 42 is longer than the first elastic member 5. Each attaching member 41 attaches the collar 42 to the housing 20. Accordingly, both the collar 42 and the attaching member 41 are integrally attached to the housing 20.

Consequently, the piping block 4 is attached to the housing 20 (at the actuator 2) via the first elastic members 5.

As shown in FIG. 2, each of the piping through holes 43 has a female screw thread 43a on the inner surface of their upper portions. An attaching part 30 is attached to the female screw thread 43a. As a result, each metallic pipe 3 is attached to the piping block 4 via the attaching member 30.

In addition, at the lower side of each of the piping through holes 43, a buffer pipe 6 is arranged. The buffer pipe 6 is attached between the piping block 4 and the housing 20.

The buffer pipe 6 is manufactured by molding an elastic material (for example, an elastic material such as a rubber material and an elastically deformable resin material) into substantially the form of a tube. The buffer pipe 6 is attached to the housing 20 by a retaining structure 62, and the buffer pipe 6 is attached to the piping block 4 by a retaining structure 63. Therefore, a gap between the piping block 4 and the housing 20 is sealed. The fluid paths 20a that are disposed in the housing 20 are connected to the piping through holes 43 formed in the piping block 4 via the buffer pipes 6.

The retaining structure 62 includes a lower attaching part 60 that is provided at the lower axial end of the buffer pipe 6 and a housing support part 20b that is provided in the housing 20. Similarly, the retaining structure 63 includes an upper attaching part 61 that is provided at the upper axial end of the buffer pipe 6 and a block support part 44 that is provided in the piping block 4.

At least a part of the attaching part 60 and at least a part of the attaching part 61 have tapered portions respectively broadening in circumference towards the lower and upper axial ends of the buffer pipe 6 and creating tapered surfaces. On the other hand, each of the support parts 20b and 44 is configured in the form of a groove. At least a part of the support part 20b and at least a part of the support part 44 have tapered portions respectively broadening in circumference towards the back of the grooves (in a direction towards the interior of the housing or piping block respectively) conforming to the forms of the attaching parts 60 and 61 and also creating tapered surfaces. Accordingly, the tapered portions of the attaching parts 60 and 61 and the tapered portions of the support parts 20b and 44 may contact at their faces (i.e., tapered surfaces) when the attaching parts 60 and 61 are inserted into the support parts 20b and 44.

In other words, the retaining structures have the attaching parts 60 and 61 at the axial ends of the buffer pipe 6 and the support parts 20b and 44 on the inside of the actuator 2 and the piping block 4, and both combinations of attaching parts and the support parts have corresponding tapered portions and tapered surfaces. Accordingly, the attaching parts 60 and 61 and the support parts 20b and 44 may restrain the movement of the buffer pipe 6 in a removal direction by utilizing the cone angles of the tapered portions.

In addition, the buffer pipe 6 is made of an elastic material as described above. Therefore, the buffer pipe 6 may be expanded in a circumferential direction when the fluid pressure (hydraulic pressure) in the buffer pipe 6 becomes high. When the buffer pipe 6 expands, the buffer pipe 6 may more tightly and more closely contact the engaging surfaces (tapered surfaces, etc.) of the support parts 20b and 44 as compared to conditions prior to the expansion (i.e., when the fluid pressure was lower). The expansion of the external surfaces of the attaching parts 60 and 61 results in the retaining structures more securely inhibiting the movement of the buffer pipe 6 in a removing direction.

In other words, before the fluid pressure within the buffer pipe 6 expands the buffer pipe 6 (i.e., a period of relatively low pressure) or while the fluid pressure within the buffer pipe 6 expands the buffer pipe 6 (i.e., a period of relatively high pressure), the retaining structures may prevent the buffer pipe 6 from being inadvertently removed from the actuator 2 or the piping block 4. In particular, when the fluid pressure expands the buffer pipe 6, the retaining structure may more strongly prevent the inadvertent removal of the buffer pipe 6 as compared to a lower fluid pressure situation before expansion.

Accordingly, the actuator 2 and the piping block 4 are able to stably retain the buffer pipe 6 due to the retaining structure. Particularly, since the buffer pipes 6 may be molded from an elastic material, the buffer pipes 6 are likely to be expanded by the fluid pressure, thereby increasing the ability of the retaining structure to stably retain the buffer pipes 6.

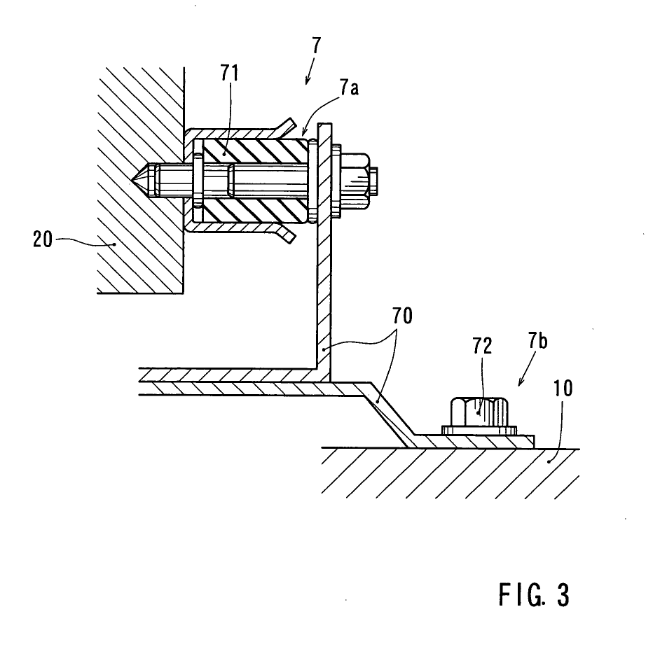

In addition, as shown in FIG. 3, the housing 20 is provided with attaching structures 7 (only one attaching structure is shown in FIG. 3) to be attached to a vehicle body 10, such as the frame or body structure of an automobile for example. The attaching structures 7 may attach the actuator 2 to the vehicle body 10. Each attaching structure 7 has a bracket 70, a first attaching structure 7a, and a second attaching structure 7b.

The first attaching structure 7a has a second elastic member 71 and attaches the housing 20 to the bracket 70 via a second elastic member 71. In addition, the second attaching structure 7b has an attaching member 72 and attaches the bracket 70 to the vehicle body 10. Accordingly, the actuator 2 is attached to the vehicle body 10 via the second elastic member 71.

The brake unit 1 is configured as described above. Thus, as shown in FIG. 2, the actuator 2 is coupled to the metallic pipes 3 via the piping block 4 and the buffer pipes 6. As a result, the oscillation of the actuator 2 is buffered by the buffer pipes 6 and the oscillation is prevented from being directly transmitted to the metallic pipes 3.

In addition, the actuator 2 is coupled to the metallic pipes 3 via the piping block 4 and the first elastic members 5. Consequently, the first elastic members 5 buffer the oscillation of the actuator 2 and the oscillations are prevented from being directly transmitted to the metallic pipes 3. Thus, the subsequent occurrence of the unpleasant sensation felt by the passengers due to the noise generated by the oscillations of the metallic pipes 3 is also inhibited.

In addition, since the metallic pipes 3 are inhibited from oscillating due to the isolation effects of the buffer pipes 6 and the first elastic members 5, the usable life of the metallic pipes 3 are extended. In addition, conventionally the metallic pipes 3 are attached to the vehicle body 10 via resin clips in order to absorb transmitted oscillations. However, according to the present embodiment, since the oscillations of the metallic pipes 3 are inhibited, it is possible to simplify the structure of the clips and/or decrease the total number of clips used.

### A SECOND EMBODIMENT

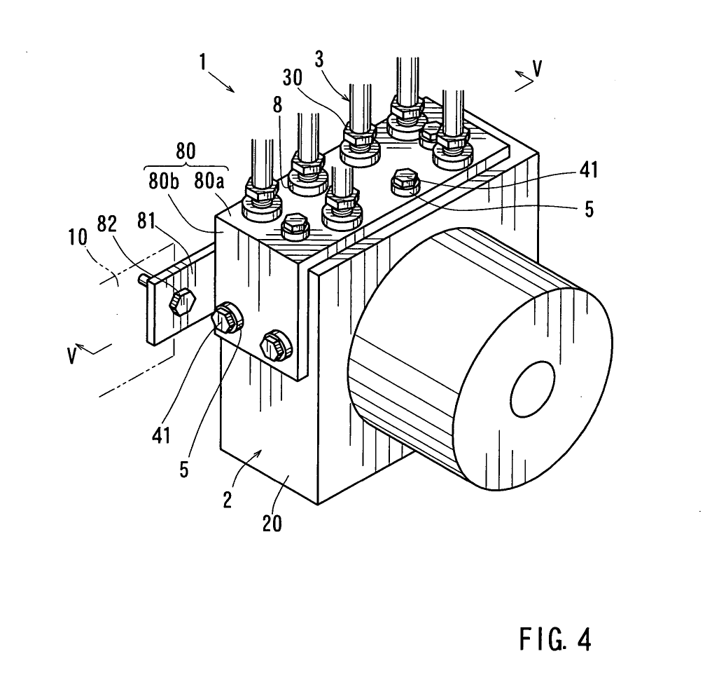

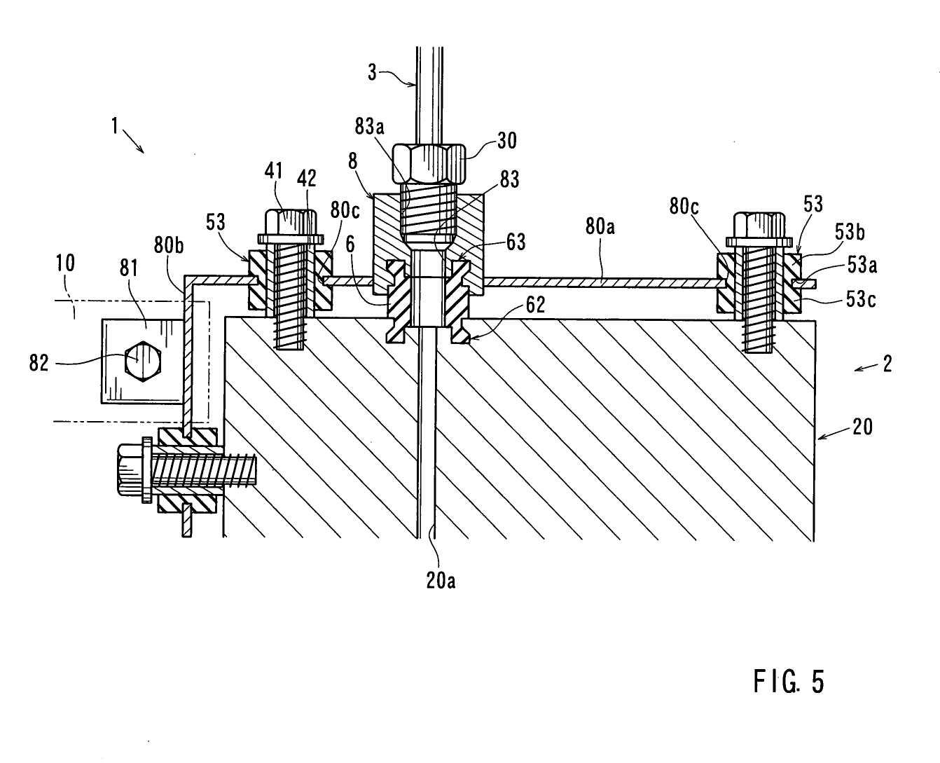

With respect to FIGS. 4 and 5, the second embodiment will be described below. A brake unit 1A according to the second embodiment is approximately identical to the first embodiment with an exception that a piping block 8 and a plate part 80 shown in FIG. 4 are provided in place of the piping block 4 shown in FIG. 1. The primary differences between the first embodiment and the second embodiment will be described below. In the description and as shown in FIG. 4 and FIG. 5, identical reference numerals are given to the elements that are similar or identical to the elements described in the first embodiment.

As shown in FIG. 4, the brake unit 1A has a plurality of piping blocks 8 equal to the number of metallic pipes 3. Each metallic pipe 3 is attached to a respective piping block 8.

The piping blocks 8 are welded to the plate part 80 so as to be integrally attached to the plate part 80. The plate part 80 is formed from a metallic plate and integrally includes an upper surface portion 80a and a side surface portion 80b. The plate part 80 extends along a portion of the external surface of the housing 20. The upper surface portion 80a extends along the upper surface of the housing 20 and the side surface portion 80b extends along a side surface of the housing 20.

As shown in FIG. 5, a plurality of through holes 80c are formed in the upper surface portion 80a and the side surface portion 80b. Tubular first elastic members 53 and collars 42 are inserted through each through hole 80c. Attaching members 41 are inserted at the center of each collar 42. Then, one end of each attaching member 41 is attached to the housing 20, so that each collar 42 and each first elastic member 53 are attached to the housing 20 via the attaching members 41.

The first elastic member 53 may be made of an elastic material (such as a rubber material and an elastically deformable resin material). In addition, each first elastic member 53 has a concave portion 53a located near the middle of its external circumferential surface. The first elastic member 53 has a locking part 53b located above the concave portion 53a and has a locking part 53c located below the concave portion 53a. These locking parts 53b and locking parts 53c have diameters that are larger than a diameter of the through hole 80c. After the tubular first elastic member 53 is inserted into the through hole 80c, the first elastic member 53 is respectively locked (i.e. held in position) by the upper end surface and the lower end surface of the plate part 80 by the locking parts 53b and 53c. Thus, the plate part 80 is attached to the housing 20 via the first elastic member 53.

As shown in FIG. 5, each piping block 8 has a through hole 83. The through hole 83 has a female screw thread 83a on the inner surface of its upper portion. The attaching part 30 is attached to the female screw thread 83a, and via the attaching member 30, the metallic pipe 3 is attached to the piping block 8.

In addition, at the lower side of the through hole 83, each buffer pipe 6 is arranged and attached between the piping block 8 and the housing 20.

Each buffer pipe 6 is manufactured by molding an elastic material (such as a rubber material and an elastically deformable resin material) into the form of a tube as in the first embodiment. For this embodiment, the buffer pipes 6 couple the through holes 83 to the fluid paths 20a of the housing 20. The buffer pipes 6 are attached to the housing 20 by a retaining structure 62 and the buffer pipes 6 are attached to the piping block 8 by a retaining structure 63.

As shown in FIG. 4, a bracket 81 is secured to the plate part 80 (located in this embodiment along the side surface portion 80b for example).

The bracket 81 is formed from a metallic plate that extends from the side surface portion 80b toward the vehicle body 10. As shown in FIG. 5, the bracket 81 is provided with a through hole penetrating in a direction of thickness and an attaching member 82 (for example, a bolt) is inserted into the through hole. The bracket 81 is then attached to the vehicle body 10 via the attaching member 82.

The brake unit 1A is configured as described above. Therefore, as shown in FIG. 5, by attaching the piping blocks 8 to the vehicle body 10, the actuator 2 is attached to the vehicle body 10 via the piping blocks 8, the plate part 80, and the first elastic members 53.

Accordingly, the elastic members 53 buffer the oscillation of the actuator 2, so that the oscillations of the actuator 2 are inhibited from being transmitted to the vehicle body 10 by the first elastic members 53.

In addition, the first elastic members 53 may also inhibit the oscillation of the actuator 2 from being transmitted to the metallic pipes 3. Accordingly, the first elastic members 53 may simultaneously play a roll in inhibiting the oscillation of the actuator 2 from being transmitted to the vehicle body 10 and in inhibiting the oscillation of the actuator 2 from being transmitted to the metallic pipes 3. Thus, according to the present embodiment, it is possible to effectively isolate the oscillations of the actuator 2.

### OTHER EMBODIMENTS

The present invention is not limited to the first and second embodiments; the following embodiments may be established.

(1) According to the first embodiment, as shown in FIG. 1 the attaching members 41 connect the actuator 2 to the piping block 4. The actuator 2 is then attached to the vehicle body. However, there is an embodiment in which the actuator 2 is not connected to the piping block 4 with attaching members 41, and both the actuator 2 and the piping block 4 are separately (and possibly independently) attached to the vehicle body. The actuator 2 is attached to the vehicle body via second elastic members, so that the second elastic members buffer the oscillation of the actuator 2. In this way, the oscillation is isolated so as to be prevented from being transmitted to the vehicle body. On the other hand, the piping block 4 is coupled to the actuator 2 via the buffer pipes 6 in the same manner as in the first embodiment. Therefore, the piping block 4 does not suffer from the oscillations of the actuator 2. The piping block 4 does not transmit the oscillations of the actuator 2 even when the piping block 4 is directly attached to the vehicle body without intervening second elastic members or the like.

(2) In addition, according to the first embodiment, the actuator 2 and the piping block 4 are integrated by attachment means and the actuator 2 is attached to the vehicle body. However there is an embodiment in which the piping block 4 is attached to the vehicle body instead of the actuator 2. In this case, in the same manner as in the second embodiment, the first elastic member 5 may inhibit the oscillation of the actuator 2 from being transmitted to the vehicle body and further, may inhibit the oscillation of the actuator 2 from being transmitted to the metallic pipes 3.

1. A brake unit comprising:
an actuator for performing an anti-lock brake function,
a piping block,
at least one metallic pipe attached to the piping block, and
a buffer pipe corresponding to each metallic pipe,
wherein the buffer pipe is made of an elastic material, and
wherein the piping block is coupled to the actuator via the buffer pipe.

2. The brake unit according to claim 1, further comprising:
at least one first elastic member,
wherein the piping block is attached to the actuator via the first elastic members.

3. The brake unit according to claim 2,
wherein the piping block is configured so as to be attached to a body of a vehicle, and
wherein the actuator is attached to the body of a vehicle via the piping block and the first elastic member.

4. The brake unit according to claim 1, further comprising:
at least one second elastic member,
wherein the actuator and the piping block are configured so as to each be separately attached to a body of the vehicle, and
wherein at least the actuator is attached to the body of the vehicle via the second elastic member.

5. The brake unit according to claim 1, further comprising:
a first retaining structure for each buffer pipe,
wherein the first retaining structure attaches the buffer pipe to the actuator.

6. The brake unit according to claim 5, wherein the first retaining structure comprises:
a first attaching part that is disposed at a first end portion of the buffer pipe, and
a first support part that is disposed at the actuator;
wherein the first attaching part has a tapered portion including a tapered surface broadening in circumference towards the first end portion of the buffer pipe,
wherein the first support part is configured to engage the first attaching part when the first end portion of the buffer pipe is inserted into the actuator,
wherein the first support part is provided with a tapered portion including a tapered surface corresponding to the tapered portion of the first attaching part, and
wherein the engagement is established so as to prevent the first attaching part from being inadvertently removed from the first support part due at least in part to contact between the tapered portions along the tapered surfaces.

7. The brake unit according to claim 6, further comprising:
a second retaining structure for each buffer pipe,
wherein the second retaining structure attaches the buffer pipe to the piping block.

8. The brake unit according to claim 7, wherein the second retaining structure comprises:
a second attaching part that is disposed at a second end portion of the buffer pipe, and
a second support part that is disposed at the piping block;
wherein the second attaching part has a tapered portion including a tapered surface broadening in circumference towards the second end portion of the buffer pipe,
wherein the second support part is configured to engage the second attaching part when the second end portion of the buffer pipe is inserted into the piping block,
wherein the second support part is provided with a tapered portion including a tapered surface corresponding to the tapered portion of the second attaching part, and
wherein the engagement is established so as to prevent the second attaching part from being inadvertently removed from the second support part due at least in part to contact between the tapered portions along the tapered surfaces.

9. The brake unit according to claim 1, further comprising:
a second retaining structure for each buffer pipe,
wherein the second retaining structure attaches the buffer pipe to the piping block.

10. The brake unit according to claim 9, wherein the second retaining structure comprises:
a second attaching part that is disposed at a second end portion of the buffer pipe, and
a second support part that is disposed at the piping block;
wherein the second attaching part has a tapered portion including a tapered surface broadening in circumference towards the second end portion of the buffer pipe,
wherein the second support part is configured to engage the second attaching part when the second end portion of the buffer pipe is inserted into the piping block,
wherein the second support part is provided with a tapered portion including a tapered surface corresponding to the tapered portion of the second attaching part, and
wherein the engagement is established so as to prevent the second attaching part from being inadvertently removed from the second support part due at least in part to contact between the tapered portions along the tapered surfaces.

11. The brake unit according to claim 1, comprising two or more metallic pipes;
wherein each the metallic pipe is coupled to the actuator via the corresponding buffer pipe.

12. The brake unit according to claim 11,
wherein the piping block is formed as a single member to be connected to a plurality of metallic piping.

13. The brake unit according to claim 11, further comprising:
a plate part;
wherein the piping block comprises two or more block members;
wherein each block member is connected to corresponding the metallic pipe; and
wherein the plate part connects the block members to each other.
